(19) United States
(12) Patent Application Publication
(10) Pub. No.: US 2019/0280288 A1
(43) Pub. Date: Sep. 12, 2019

(54) ASYMMETRIC, SECONDARY ELECTROCHEMICAL CELL

(71) Applicant: VARTA Microbattery GmbH, Ellwangen Jagst (DE)

(72) Inventors: David Ensling, Ellwangen (DE); Edward Pytlik, Ellwangen (DE); Claudio Schula, Ellwangen (DE); Ihor Chumak, Ellwangen (DE)

(21) Appl. No.: 16/348,994

(22) PCT Filed: Nov. 21, 2017
(86) PCT No.: PCT/EP2017/079979

§ 371 Date: May 10, 2019

(30) Foreign Application Priority Data
Nov. 21, 2016 (EP) 16199766.3

(51) Int. Cl. H01M 4/32; H01M 10/30; H01M 4/52; H01M 4/583

(52) U.S. Cl. CPC H01M 4/32; H01M 10/30; H01M 2004/027; H01M 4/583; H01M 2300/0002; H01M 4/52

(57) ABSTRACT

An asymmetric, secondary electrochemical cell having an aqueous, alkaline electrolyte includes a negative electrode which as anode storage material includes a carbon-based storage material that allows the storage of electric charge in the electrode by formation of an electric double layer and also an additional storage material that can store electric energy by redox reactions. The positive electrode of the cell includes nickel hydroxide and/or nickel oxyhydroxide and/or a derivative of these nickel compounds as cathode storage material. The capacity of the negative electrode Kₙ has a ratio X to the capacity of the positive electrode Kₚ of 0.7:1 to 5:1. The additional storage material is present in a proportion of 0.1 to 8% by weight in the negative electrode, based on the dry weight thereof.

### TECHNICAL FIELD

This disclosure relates to an asymmetric, secondary electrochemical cell having an aqueous, alkaline electrolyte. The cell has a negative electrode that as anode storage material comprises a carbon-based storage material which allows storage of electric charge in the electrode by formation of an electric double layer (Helmholtz double layer) and also a positive electrode that as cathode storage material comprises nickel hydroxide and/or nickel oxyhydroxide and/or a derivative of these nickel compounds.

### BACKGROUND

Electrochemical cells always comprise a positive electrode and a negative electrode. During discharge of an electrochemical cell, an energy-supplying chemical reaction made up of two electrically coupled but spatially separated partial reactions takes place. One partial reaction that takes place at a comparatively lower redox potential proceeds at the negative electrode, and a partial reaction proceeds at a comparatively higher redox potential at the positive electrode. During discharge, electrons are liberated at the negative electrode by an oxidation process, resulting in an electron current, usually via an external load, to the positive electrode by which a corresponding amount of electrons is taken up. Thus, a reduction process takes place at the positive electrode. At the same time, an ion current corresponding to the electrode reaction occurs within the cell. The ion current is ensured by an ionically conductive electrolyte. In secondary electrochemical cells, the discharging reaction is reversible so that it is possible to reverse the conversion of chemical energy into electric energy that occurred during discharge. When the terms anode and cathode are used in this context, the electrodes are generally named according to their discharging function. The negative electrode in such cells is thus the anode, and the positive electrode is the cathode.

Asymmetric, secondary electrochemical cells having an aqueous, alkaline electrolyte have been known for some years, in which cells the negative electrode comprises as anode storage material a carbon-based storage material that allows the storage of electric charge in the electrode by formation of an electric double layer (Helmholtz double layer), while the positive electrode comprises as cathode storage material a material that can store electric energy by a redox reaction. Examples of such systems are described in WO 2016/005529 A1 or WO 2016/020136 A2. A suitable anode storage material is, for example, activated carbon. As cathode storage material, it is possible to use, for example, nickel hydroxide/nickel oxyhydroxide or iron oxide/iron. In such cells, the positive electrode is charged by a Faraday process, while the negative electrode forms an electric double layer at the interface between the anode storage material and the electrolyte during charging.

A problem associated with cells having that type of construction is that the positive electrode and the negative electrode have very different self-discharge rates. In general, the self-discharge rate of the negative electrode is very much higher than that of the positive electrode. This leads to great problems, particularly in charging operations. If a cell whose negative electrode has a lower state of charge than the positive electrode is charged, the positive electrode is either overcharged or else the charging operation has to be stopped before the negative electrode has reached its full capacity.

### SUMMARY

We provide an asymmetric, secondary electrochemical cell including a negative electrode containing as anode storage material a carbon-based storage material that allows the storage of electric charge in the electrode by formation of an electric double layer and an additional storage material that can store electric energy by redox reactions, and an anode current collector; a positive electrode containing as cathode storage material nickel hydroxide and/or nickel oxyhydroxide and/or a derivative of these nickel compounds, and a cathode current collector; at least one porous separator layer having a first flat side and a second flat side between the negative electrode and the positive electrode; an aqueous, alkaline electrolyte with which the electrodes and the separator are impregnated; a housing that encloses the electrodes, the separator and the electrolyte, wherein the first flat side includes a first region which is in areal contact with the anode storage material of the negative electrode and the second flat side includes a second region which is in areal contact with the cathode storage material of the positive electrode, the first region and the second region overlap at least partly in an overlap region, the additional storage material is present in a proportion of 0.1 to 8% by weight in the negative electrode, based on the dry weight thereof, and the capacity of the negative electrode Kₙ has a ratio X to the capacity of the positive electrode Kₚ of 0.7:1 to 5:1.

### BRIEF DESCRIPTION OF THE DRAWINGS

FIG. 1 shows a first example of a cell (photograph of a central section through the cell).

FIG. 2 shows a second example of a cell (photograph of a central section through the cell).

### DETAILED DESCRIPTION

Our asymmetric, secondary electrochemical cell has a negative electrode and a positive electrode coupled thereto with electrons being liberated at the negative electrode during charging of the cell while a corresponding amount of electrons is taken up at the same time by the positive electrode.

The negative electrode comprises, as anode storage material, a carbon-based storage material that allows storage of electric charge in the electrode by formation of an electric double layer (Helmholtz double layer). In addition, the negative electrode comprises an anode current collector. The positive electrode comprises nickel hydroxide and/or nickel oxyhydroxide and/or a derivative of the nickel compounds as cathode storage material. In addition, the positive electrode comprises a cathode current collector. A porous separator layer having a first flat side and a second flat side is arranged between the negative electrode and the positive electrode. Both the electrodes and the separator are impregnated with an aqueous, alkaline electrolyte. The electrodes, the separator and the electrolyte are enclosed by a housing.

The first flat side of the separator layer comprises a first region in areal contact with the anode storage material of the negative electrode, in particular covered with this material. The second flat side of the separator layer comprises a second region in areal contact with the cathode storage material of the positive electrode, in particular covered with this material. The first region and the second region, and thus also the negative electrode and the positive electrode, overlap at least partly in an overlap region.

One possible way of avoiding or at least reducing the problems arising as a result of the different self-discharge rates of the electrodes of asymmetric cells is to set a clearly defined ratio of the capacities of positive electrode and negative electrode.

Our cell is characterized in that the capacity of the negative electrode Kₙ and the capacity of the positive electrode Kₚ have a ratio X to one another of 0.7:1 to 5:1 (Kₙ:Kₚ).

The capacity of the negative electrode Kₙ and the capacity of the positive electrode Kₚ preferably have a ratio X to one another of 1:1 to 5:1. Within this range, greater preference is given to a capacity ratio of negative electrode/positive electrode of 1:1 to 2:1, preferably 1:1 to 1.5:1, particularly preferably 1:1 to 1.1:1.

The capacities of negative and positive electrodes Kₙ and Kₚ are therefore balanced in a particular ratio to one another.

The negative electrode preferably comprises at least one of the following features, in particular also a plurality of the following features:

The carbon-based storage material is preferably at least one material selected from the group consisting of activated carbon (AC), activated carbon fibers (AFC), carbide-derived carbon (CDC), carbon aerogel, graphite (graphene) and carbon nanotubes (CNTs).

Activated carbon is a porous, particularly finely particulate carbon modification having a large internal surface area. Activated carbon preferably has a BET surface area of at least 800 m²/g, preferably at least 900 m²/g (as determined in accordance with DIN ISO 9277). As an alternative or in addition, the activated carbon has a capacity value of at least 60 F/g (determined in accordance with DIN IEC 62391).

Activated carbon fibers can be obtained from activated carbon. They are likewise porous, have a large internal surface area and usually have a typical diameter of about 10 μm. Apart from a high specific capacity, activated carbon fibers have an extraordinarily good conductivity along the fiber axis.

Carbon aerogel is a synthetic, highly porous material composed of an organic gel in which the liquid component of the gel has been replaced by a gas by pyrolysis. Carbon aerogels can, for example, be produced by pyrolysis of resorcinol-formaldehyde. They have a better electrical conductivity than activated carbon.

Carbide-derived carbons consist of a number of materials made from carbides, for example, silicon carbide and titanium carbide by thermal decomposition or chemical halogenation to convert them into pure carbon. Electrodes composed of carbide-derived carbons have large surface areas with tailored pore sizes. In general, electrodes composed of CDC have a higher energy density than electrodes composed of activated carbon.

Graphene is a carbon modification having a two-dimensional structure. Many concatenated benzene rings form a honeycomb pattern in which each carbon atom is surrounded at an angle of 120° by three further carbon atoms and in which all carbon atoms are sp²-hybridized. Graphene offers the greatest surface area per unit weight that can theoretically be achieved for carbon and is therefore currently the subject of intensive studies in connection with the development of supercapacitors.

Carbon nanotubes are graphene layers shaped to give cylindrical nanotubes. There are single-walled nanotubes and multi-walled nanotubes in which a plurality of single-walled nanotubes have been nested coaxially within one another. CNT-based electrodes generally have a smaller electrode surface area than electrodes based on activated carbon. Regardless, higher capacities can fundamentally be achieved with CNTs than with activated carbon electrodes.

The carbon-based materials mentioned can also be used in combination with one another. Any mixing ratio is possible.

The carbon-based storage material is preferably present in a proportion of 10 to 94.9% by weight, particularly preferably 40 to 94.9% by weight, in the negative electrode.

These percentages are based on the weight of the total negative electrode, i.e. on the weight of the electrode including the anode storage material, the anode current collector and any solid additives present, e.g. an electrode binder (see below). However, the electrolyte with which the electrode is impregnated is not included. The percentages mentioned relate to the electrode in the dried (proportional water <2% by weight) state before it is impregnated with the electrolyte. This stage of an electrode will hereinafter also be referred to as the dry weight of this electrode.

All percentages indicated below specifying the proportions in the negative electrode are likewise based on the weight of the total negative electrode. The percentages of the participating electrode constituents each add up to 100% by weight.

Particularly preferably, the negative electrode contains as anode storage material not only the carbon-based storage material, but also an additional storage material that can store electric energy by redox reactions.

This additional storage material is preferably a material that can be reversibly oxidized and reduced in an aqueous alkaline electrolyte. Preferred examples are the redox pair iron/iron oxide or a redox-active compound such as titanium dioxide. Further particularly suitable materials are hydrogen storage alloys. In alkaline solution, these can bind hydrogen in hydric form and also liberate it again. Suitable hydrogen storage alloys are, for example, AB₂ alloys, AB₅ alloys, A₂B₇ alloys or AB₃ alloys. Mischmetal is also suitable as additional storage material.

Addition of the additional storage material enables the different self-discharge rates of positive and negative electrodes to be made similar. The stable potential of the storage material stabilizes the self-discharge behavior of the negative electrode.

The abovementioned preferred capacity ratios X of 1:1 to 2:1 can be realized particularly when the negative electrode comprises the additional storage material. Fundamentally, the capacity ratio of negative electrode to positive electrode in the presence of the additional storage material can very much more easily be decreased in the direction of 1:1 or even 0.7:1 than without the additional storage material.

This additional storage material is particularly preferably present in a proportion of 0.1 to 8% by weight in the negative electrode. Within this range, a proportion of 1.0 to 3% by weight is frequently more preferred.

The total anode storage material is preferably present in a proportion of 10 to 95% by weight, particularly preferably 40 to 95% by weight, in the negative electrode.

The negative electrode preferably contains an electrode binder. This can be, for example, polytetrafluoroethylene (PTFE). As an alternative, it is possible to use, for example, carboxymethyl cellulose (CMC), methyl hydroxypropyl cellulose (HPMC), styrene-butadiene rubber (SBR), polyvinyl alcohol (PVA), polyethylene oxide (PEO) or polyacrylate-based binders as electrode binder.

The electrode binder is preferably present in a proportion of 0.1 to 30% by weight in the negative electrode. In some examples of a cell, a proportion of 0.1 to 5% by weight is more preferred.

The negative electrode can preferably be present as a tablet. It can have a disk-like or prismatic shape, i.e., for example, with rectangular or hexagonal geometry. In general, the term tablet refers to, in particular, any body having a disk-like or prismatic geometry resulting from a pressing or compaction operation and having a self-supporting structure. In particular, it can also be a composite body. For example, the negative electrode can be configured as a tablet comprising a three-dimensional, metallic conductive matrix described in more detail below and in which the anode storage material is embedded. Such a tablet can, for example, be produced by introduction of a paste containing the anode storage material into an open-pored metal foam and subsequent drying and compaction of the metal foam containing the anode storage material.

The tablet can be obtained directly from a pressing operation or else can be formed by a stamping operation in which it is, for example, stamped from a layer containing the anode storage material.

As an alternative, the negative electrode can be present as thin, strip- or tape-like layer electrode. The electrode is considered to be present in strip- or tape-like form when, in particular, its length exceeds its width by a factor of 3 or more. An electrode is described as thin when, in particular, its thickness is not more than 1.5 mm, particularly preferably not more than 1 mm.

The anode current collector is preferably a power outlet lead forming a three-dimensional conductive matrix in which the anode storage material is embedded. In particular, the anode current collector is an electrically conductive foam, an electrically conductive nonwoven, an electrically conductive felt or an electrically conductive woven fabric. It preferably consists of a metal, for example, nickel. The anode current collector is particularly preferably a nickel foam.

As an alternative, the anode current collector can be a mesh or gauze surrounding the negative electrode.

The anode current collector does not necessarily have to be completely covered with anode storage material. There are, for example, examples of negative electrodes in which a strip-like anode current collector is covered in the middle with anode storage material, but has uncovered peripheral regions along its longitudinal sides.

The anode current collector preferably contributes a proportion of 5 to 60% by weight to the total weight of the negative electrode. The upper limit of this range is, however, generally reached only when the specific weight of the anode storage materials used is very low.

The negative electrode preferably has a specific capacity K1 of 1 to 150 mAh/g. In some examples of a cell, a capacity K1 within this range of 10 to 100 mAh/g, particularly preferably of 20 to 60 mAh/g, is more preferred.

The capacity values are based on the dry weight of the electrode as defined above, i.e. on the weight of the total electrode including the anode storage material, the anode current collector and any solid additives present but without taking into account the electrolyte.

The positive electrode preferably comprises at least one of the following features, in particular a plurality of the following features:

The cathode storage material is nickel hydroxide and/or nickel oxyhydroxide and/or a derivative of these nickel compounds.

Nickel hydroxide exists in two crystalline forms, namely in an alpha form (α-Ni(OH)₂) and in a beta form (β-Ni(OH)₂). It is possible to use α- or β-Ni(OH)₂. It is also possible to use α and β mixed phases.

Nickel oxyhydroxide (NiOOH) can be formed from Ni(OH)₂ during operation of the cell. However, NiOOH can particularly advantageously also be added initially, i.e. before first operation of the cell, either in place of the Ni(OH)₂ or in addition to the latter. The cell is in this example already charged or at least partly charged immediately after it has been manufactured.

The derivative is, in particular, a derivative of the formula Ni₁₋ₓMx(OH)₂, where M is at least one substituted metal atom, for example, from the group consisting of Mg, Al, Ca, Co, Cr, Sn, Cu, Zn, Cd, Mn, Fe, Y and Yb. In α-nickel hydroxide, Mg, Al, Ca, Co, Cr, Sn, Cu, Zn and Cd are particularly preferred as substituents. In β-nickel hydroxide, Al, Mn, Fe, Co, Cu, Zn, Y and Yb are particularly preferred as substituents.

α-Ni(OH)₂ is present as a metastable phase. During storage in an aqueous alkaline solution, it is generally transformed quickly into the β form. The metastable phase can be stabilized by replacing part of the nickel atoms by cobalt. Particularly preferably, Ni₁₋ₓMx(OH)₂ where M=Co and x=0.01 to 0.5 is used as cathode storage material.

Furthermore, it is also possible to use coated Ni(OH)₂. An example is provided by particles of Ni(OH)₂, the surface of which is coated with Co and/or with CoOOH to improve conductivity.

α-Ni(OH)₂ in particular can contain not only hydroxide ions in incorporated form, but also further anions, for example, from the group consisting of nitrate ions, chloride ions, sulfate ions, carbonate ions, cyanate ions, acetate ions, succinate ions, glutarate ions and adipate ions. Due to a higher packing density, incorporation of foreign anions into β-Ni(OH)₂ is significantly rarer.

Particular preference is given to spherical β-Ni(OH)₂ having a D50 of 8-15 μm as cathode storage material in a cell. In one example, part of the nickel atoms in this β-Ni(OH)₂ can be replaced by Co and/or Zn atoms.

The positive electrode contains at least one conductivity improver, preferably from the group consisting of nickel, cobalt, cobalt oxide, cobalt carbonate, cobalt hydroxide, graphite, hard carbon, soft carbon and carbon black, in addition to the cathode storage material.

The at least one conductivity improver in the positive electrode particularly advantageously brings about an increase in the self-discharge rate thereof. The addition of the conductivity improver can thus serve to equalize the different self-discharge rates of positive and negative electrodes. This applies particularly when the above-described additional storage material, which can store electric energy by redox reactions, is at the same time present in the negative electrode.

The at least one conductivity improver is particularly preferably present in a proportion of 0.1 to 25% by weight in the positive electrode.

These percentages are based on the weight of the total positive electrode, i.e. on the weight of the electrode including the cathode storage material, the cathode current collector and any solid additives present, e.g. an electrode binder (see below). However, the electrolyte with which the electrode is impregnated is not included. The percentages mentioned relate to the electrode in the dried (proportion of water <2% by weight) state before it is impregnated with the electrolyte. This state of an electrode will also be referred to as the dry weight of this electrode.

All percentages indicated below specifying proportions in the positive electrode are likewise based on the weight of the total negative electrode.

The cathode storage material is preferably present in a proportion by weight of 1 to 95% by weight, particularly preferably 10 to 95% by weight, in the positive electrode.

Preferably, the positive electrode contains an electrode binder. This can be, for example, carboxymethyl cellulose (CMC) or a CMC derivative. As an alternative, it is possible to use, for example, methyl hydroxypropyl cellulose (HPMC), styrene-butadiene rubber (SBR), polyvinyl alcohol (PVA), polyethylene oxide (PEO) or polyacrylate-based binders as electrode binder.

The electrode binder is preferably present in a proportion of 0.1 to 8% by weight in the positive electrode.

Preferably, the positive electrode is present as a tablet or as thin, strip- or tape-like layer electrode. The terms tablet and layer electrode are defined in the same way as in the negative electrode.

The cathode current collector is preferably a power outlet lead forming a three-dimensional conductive matrix in which the cathode storage material is embedded, in particular an electrically conductive foam, an electrically conductive nonwoven, an electrically conductive felt or an electrically conductive woven fabric.

As an alternative, the cathode current collector can also be an electrically conductive foil, an electrically conductive gauze or an electrically conductive mesh, for example, an expanded metal mesh.

The cathode current collector does not necessarily have to be completely covered with cathode storage material. There are, for example, examples of positive electrodes in which a strip-like cathode current collector is covered in the middle with cathode storage material, but has uncovered peripheral regions along its longitudinal sides.

The cathode current collector is present in a proportion by weight of 5 to 60% by weight in the positive electrode. The upper limit of this range is generally reached only when the specific weight of the anode storage materials used is very low.

The positive electrode has a specific capacity K2 of 40 to 310 mAh/g, preferably 50 to 240 mAh/g, particularly preferably 60 to 200 mAh/g.

The capacity values indicated are based on the dry weight of the electrode as defined above, i.e. the weight of the total electrode including the cathode storage material, the cathode current collector and any solid additives present but without taking into account the electrolyte.

As the separator layer, preference is given to using a porous sheet-like structure permeable to ions that migrate back and forth between the positive electrode and the negative electrode, but at the same time electrically insulate the electrodes from one another. Possible sheet-like structures are, for example, a porous film, for example, composed of a polyolefin or a polyester. Preferably, the sheet-like structure is a nonwoven. This can likewise be made, for example, of a polyolefin or a polyester.

The aqueous alkaline electrolyte is preferably an aqueous solution of at least one alkali metal hydroxide and/or alkaline earth metal hydroxide. The electrolyte particularly preferably contains at least one hydroxide selected from the group consisting of sodium hydroxide, potassium hydroxide and lithium hydroxide. The at least one hydroxide is preferably present in a concentration of 0.1 mol/l to 10 mol/l in the electrolyte.

The housing of a cell is preferably both liquid-tight and gas-tight. Gas-tight closure means that the cell does not comprise a way to enable targeted lowering of a superatmospheric pressure within the housing during normal operation of the cell, i.e., for example, an overpressure valve. However, a bursting membrane that is irreversibly destroyed when a pressure threshold value is exceeded can be provided for safety reasons.

The housing can, for example, be configured as a button cell housing, for example, as a housing as depicted in EP 1 011 163 A1. As an alternative, cells can also be configured as flat cells as described, for example, in EP 1 391 947 A1. In this example, the housing is preferably made of thin metal foils joined to one another by a sealing layer.

Preferably, the positive electrode and the negative electrode are present as part of a strip-like electrode-separator composite optionally present as spiral-like roll. In this example, the housing can preferably be configured as a button cell housing, for example, as a button cell housing as depicted, for example, in FIG. 4 of WO 2010/089152 A1. Alternatively, it can also, particularly in this example, be configured as cylindrical round cell housing.

The housing of the cells is particularly preferably a metallic housing, for example, a housing made of stainless steel or of a nickel-plated steel. This applies particularly when the housing is a button cell housing or when the housing is a cylindrical round cell housing.

When the housing is a button cell housing, particular preference is given to it comprising a metallic gauze or mesh arranged on its interior sides, in particular lies flat against its interior sides. In this way, the electrical contact between the electrodes and the corresponding parts of the button cell housing can be significantly improved.

Preferably, the button cell housing comprises a positive housing half electrically connected to the positive electrode and a negative housing half electrically connected to the negative electrode, with an interior side of the negative housing half being covered with a metallic gauze or mesh, for example, an expanded metal mesh. The metallic gauze or mesh can be joined to the negative housing half by welding.

To balance the positive electrode and the negative electrode of a cell within the desired capacity parameters, one or more parameters of the electrodes can be simultaneously matched to one another. Such parameters are, in particular, the specific capacities K1 and K2, an area F1 over which the first region (in which the anode storage material of the negative electrode is in areal contact with the first flat side of the separator layer) extends, an area F2 over which the second region (in which the cathode storage material of the positive electrode is in areal contact with the second flat side of the separator layer) extends, an average thickness D1 of the negative electrode and an average thickness D2 of the positive electrode. In mathematical terms, these parameters and the ratio X have relationship (1):

X=K1*D1*F1/K2*D2*F2 (1)

The factors K1, D1 and F1 are each proportional to the factors K2, D2 and F2. The product of K1 and D1 and F1 is Kₙ. The product of K2 and D2 and F2 is Kₚ. The capacity ratio X can thus be influenced via the specific capacities K1 and K2, the thicknesses D1 and D2 and the areas F1 and F2.

The negative electrode particularly preferably has an average thickness D1 of 30 μm to 800 μm. This figure relates to the thickness of the electrode in the first region, i.e. in the region of the first flat side of the separator layer in areal contact with the anode storage material of the negative electrode.

The positive electrode preferably has an average thickness D2 of 30 μm to 500 μm. This figure relates to the thickness of the electrode in the second region, i.e. in the region of the second flat side of the separator layer in areal contact with the cathode storage material of the positive electrode.

In a circular electrode geometry, the determination of the average thickness of an electrode is carried out, in particular, with the aid of two straight lines drawn orthogonally to one another through the midpoint of the circular electrode. The thickness of the electrode is determined at the midpoint and also at two points on each of the straight lines, namely halfway between the midpoint and the periphery of the electrode. The average thickness of the electrode corresponds to the average of the five measurement results obtained.

In a rectangular electrode geometry, determination of the average thickness of an electrode is carried out, in particular, with the aid of two straight lines drawn diagonally through the midpoint and through the four corners of the rectangular electrode. The thickness of the electrode is determined at the midpoint and also at two points on each of the straight lines, namely halfway between the midpoint and one of the four corners. The average thickness of the electrode corresponds to the average of the five measurement results obtained.

In a strip- or tape-like electrode geometry (when the length of the electrode exceeds its width by a factor of 3 or more), two straight lines are, in particular, drawn on the electrode parallel to one another and parallel to the longitudinal edges of the electrode to determine the average thickness of an electrode. The distances between the straight lines and the longitudinal edges and also the distance between the straight lines are identical. The electrode is subsequently divided into 10 equal-sized longitudinal sections. The thickness of the electrode is determined at one point on each of the two straight lines in each of the longitudinal sections. The average thickness of the electrode corresponds to the average of the twenty measurement results obtained.

Preference is given, both in the positive electrode and in the negative electrode, to each electrode having an essentially constant thickness in the first region and in the second region. “Essentially constant” means that the thickness of the negative electrode and the positive electrode preferably does not deviate by more than 25%, preferably less than 15%, from the average thickness of the respective electrode at any point.

Furthermore, preference is given for the average thickness of the negative electrode to have a ratio of 0.7:1 to 25:1 to the average thickness of the positive electrode. Within this range, a thickness ratio of “average thickness of the negative electrode/average thickness of the positive electrode” of 3:1 to 15:1 is more preferred.

Preferably, the first range and the second range (and thus also the negative electrode and the positive electrode) overlap completely with one another. This does not necessarily mean that the first region and the second region have to be of equal size in complete overlap. It merely means that the first region and the second region are not arranged relative to one another such that both a part of the first region does not overlap the second region and also a part of the second region does not overlap the first region. Thus, when the first region is smaller than the second region, according to this condition it does not have a part that does not overlap the second region, while part of the second region cannot overlap the first region. If the second region is smaller than the first region, according to this condition it does not have a part that does not overlap the first region, while part of the first region cannot overlap the second region. If the first and second regions have the same size, neither of the regions has a part that does not overlap the other region.

Particularly preferably, the first region extends over an area F1 and the second region over an area F2, where F1 and F2 have a ratio of 0.8:1 to 10:1. In this example, the negative electrode covers a ten-fold greater area on the separator layer than the positive electrode.

Further preferably, F1 and F2 have a ratio to one another of 1:1 to 1.5:1 or 0.8:1 to 1:1.

The range of 1:1 to 1.5:1 is particularly preferred when the positive electrode and the negative electrode have a strip-like or tape-like configuration. When, on the other hand, the electrodes have a disk-shaped geometry, particularly for button cells containing tablet-shaped electrodes, 0.8:1 to 1:1 is generally preferred. In this example, it is not unusual for the positive electrode to have a greater area than the negative electrode.

Particularly preferably, the negative electrode is present in the form of two separate layers and the positive electrode is present in the form of one layer, with the layers and the at least one separator being arranged in the sequence negative electrode/separator/positive electrode/separator/negative electrode. To calculate the ratio “average thickness of negative electrode (D1) to average thickness of positive electrode (D2)”, the average thicknesses of the two separate layers (D1a and D1b) are added to D1. In mathematical terms: D1a+D1b=D1.

In a positive further example, the negative electrode and the positive electrode are each present in the form of an electrode strip and the at least one separator layer is present in the form of at least one separator strip. The tape-like positive electrode and the tape-like negative electrode and the at least one separator strip are preferably processed into a tape-like electrode-separator composite in which the at least one separator strip is arranged between the positive electrode and the negative electrode. The electrode-separator composite is very particularly preferably present as spiral-like rolls.

To balance the electrodes within such a roll, the tape-like negative electrode can be made longer than the tape-like positive electrode and can overlap the latter within the electrode-separator composite at at least one end.

Since the negative electrode has a high electrical conductivity and electricity is stored in the negative electrode primarily in the form of an electric double layer, the negative electrode can without problems have regions that do not overlap the positive electrode within the roll. It is thus possible to construct rolls in which the positive electrode and the negative electrode have substantially the same thickness and balancing the positive electrode and the negative electrode is carried out exclusively over the length of the electrodes. For example, the roll can have one or more exterior windings formed exclusively by a composite of negative electrode and separator. To produce such a roll, comparatively long strip-like negative electrodes are combined with comparatively short strip-like positive electrodes. Overlapping of the negative electrode then occurs at at least one end of the roll.

On the basis of the abovementioned parameters, the capacities of the electrodes and thus also capacity ratios between negative and positive electrodes can be calculated and set in a targeted manner. In practice, however, deviations from calculated values can also occur that can be attributed, for example, to the factors K1 and K2. The values of the specific capacities K1 and K2 are dependent on a number of factors and can therefore fluctuate within the above-defined preferred ranges. K1 and K2 can be influenced by, for example, the following factors: the quality of the anode storage material and/or cathode storage material the proportion of “inactive components” in the electrode, i.e., for example, the proportion by weight of the electrode binder or the weight of the current collector the degree of densification of the electrode.

For this reason, theoretically determinable capacities and capacity ratios are in practice often checked by practical measurements.

The capacities of the negative and positive electrodes Kₙ and Kₚ are generally determined separately from one another.

For the separate determination of the capacities, the negative electrode and the positive electrode are preferably connected to over-dimensioned reference electrodes, each activated and subsequently subjected to a number of charging and discharging cycles until the electrodes display a stable charging and discharging behavior. The capacities Kₚ and Kₙ are then determined by measuring the discharge current by formula (2): Kₚ=I_{DISCHARGE CURRENT}×t_{DISCHARGE TIME} [mAh] (2). In the positive electrode, a stable charging and discharging behavior is generally attained after conclusion of the second charging and discharging cycle. In the negative electrode, a stable charging and discharging behavior is generally achieved after conclusion of the fourth charging and discharging cycle.

In this way, the capacities Kₚ and Kₙ can be determined. Taking into account the weight m of the respective electrodes examined, the specific capacities K1 (K1=Kₙ/m_{negative electrode} [mAh/g]) and K2 (K2=Kₚ/m_{positive electrode} [mAh/g]) can be calculated.

Determination of the capacity of the positive electrode Kₚ is particularly preferably carried out in a button cell test system. The positive electrode or a suitable section of the positive electrode, optionally cut or stamped from the electrode, is dried immediately after it has been produced until its water content is less than 2% by weight (based on the total weight of the electrode or of the section). The electrode or the section is impregnated with a KOH electrolyte (32% by weight of KOH) and connected to an over-dimensioned mischmetal electrode in a button cell housing.

The capacity Kₚ is determined approximately arithmetically (e.g. from the known specific capacity of the electrode active material used) or by preliminary tests.

The positive electrode is subsequently activated. For this purpose, the test cell is first charged at a constant current of 0.12 C for 10 hours, then discharged at 0.267 C for 1.5 hours and subsequently charged at 0.1 C for 4 hours. The “C values” indicated describe the respective charging and discharging currents based on the approximately determined capacity.

For the actual measurement, the test cell is discharged at 0.2 C at room temperature (23° C.±2° C.) until a final discharge voltage of 1.0 V has been reached, and subsequently charged at 0.1 C for 16 hours. This procedure is repeated twice. The capacity Kₚ of the positive electrode is determined by measuring the discharging current in the third discharging of the test cell by formula (2).

Determination of the capacity of the negative electrode Kₙ is particularly preferably carried out by a three-electrode measurement in a glass beaker. For this purpose, the negative electrode is stored for a time of 12 hours in a KOH electrolyte (32% by weight of KOH) heated to 80° C. and is subsequently connected to an over-dimensioned activated carbon electrode. An Hg/HgO electrode serves as reference electrode.

The negative electrode is charged in the potential range OCV÷−1.0 V vs. Hg/HgO at room temperature (23° C.±2° C.) first at a charging current of 23 mA/g at carbon-based storage material in the electrode (based on the dry weight (proportion of water <2% by weight) of the electrode), then discharged at a discharging current of equal magnitude (for example: at a proportion of 0.5 g of carbon-based storage material in the electrode, the charging and discharging currents are 11.5 mA). This procedure is repeated four times. The capacity Kₙ of the negative electrode can be determined by measuring the discharge current in the fifth discharge by formula (3):

Kₙ=I_{DISCHARGE CURRENT}×t_{DISCHARGE TIME} [mAh] (3).

In this way, the capacities Kₚ and Kₙ can be determined. Taking into account the weight m of the respective electrodes examined, the specific capacities (K1 (K1=Kₙ/m_{negative electrode} [mAh/g]) and K2 (K2=Kₚ/m_{positive electrode} [mAh/g]) can be calculated.

Particularly preferably, the cell is a button cell, i.e. a cell having a preferably circular cross section and whose height is smaller than its diameter. In this example, the cell preferably has at least one of the following features:

The negative electrode is a tablet having an average thickness of 0.5 mm to 3 mm.

The negative electrode comprises activated carbon as anode storage material.

As additional storage material that can store electric energy by redox reactions, the negative electrode comprises a hydrogen storage alloy or iron or iron oxide powder.

The negative electrode contains an electrode binder, preferably PTFE.

The anode current collector is a metallic mesh that envelops the negative electrode or an electrically conductive foam.

The positive electrode is present as thin layer electrode having an average thickness of 30 μm to 350 μm, preferably 150 μm to 250 μm.

The positive electrode comprises nickel hydroxide and/or nickel oxyhydroxide and/or a derivative of these nickel compounds.

The cathode current collector is an electrically conductive foam.

The average thickness of the negative electrode has a ratio of 2:1 to 20:1 to the average thickness of the positive electrode. Within this range, a ratio of 4:1 to 10:1 (average thickness on negative electrode/average thickness on positive electrode) is more preferred.

The separator is based on a polyolefin.

The electrolyte contains potassium hydroxide (KOH) or a mixture of sodium hydroxide (NaOH) and lithium hydroxide (LiOH) or a mixture of KOH, NaOH and LiOH.

The first region and the second region overlap completely.

The first region extends over an area F1 and the second region extends over an area F2, where F1 and F2 have a ratio of 0.8:1 to 1:1.

The negative electrode has a specific capacity K1 of 10 to 100 mAh/g. Within this range, K1 is preferably 20 to 60 mAh/g.

The positive electrode has a specific capacity K2 of 2 to 310 mAh/g. Within this range, K1 is preferably 5 to 240 mAh/g, particularly preferably 10 to 200 mAh/g.

The capacity of the negative electrode Kₙ has a ratio X to the capacity of the positive electrode Kₚ of 1:1 to 2:1. Within this range, a ratio of Kₙ/Kₚ of 1:1 to 1.1:1 is more preferred.

The cell of this example particularly preferably has all of the abovementioned features.

In another particularly preferred example, the cell is a button cell, i.e. a cell having a preferably circular cross section and whose height is smaller than its diameter. In this example, the cell preferably has at least one of the following features:

The negative electrode is or comprises a tablet having an average thickness of 0.2 mm to 1.8 mm.

The negative electrode comprises activated carbon as anode storage material.

As additional storage material that can store electric energy by redox reactions, the negative electrode comprises a hydrogen storage alloy, a redox-active titanium dioxide compound or iron or iron oxide powder.

The negative electrode contains a PTFE, SBR, PVA, acrylate, PEO and/or CMC binder as electrode binder.

The anode current collector is an electrically conductive foam.

The positive electrode is present as a tablet having an average thickness of 30 μm to 350 μm, preferably 150 μm to 250 μm.

The positive electrode comprises nickel hydroxide and/or nickel oxyhydroxide and/or a derivative of these nickel compounds.

The positive electrode contains a PTFE, SBR, PVA, acrylate, PEO and/or CMC binder as electrode binder.

The cathode current collector is an electrically conductive foam.

The average thickness of the negative electrode has a ratio of 2:1 to 20:1 to the average thickness of the positive electrode. Within this range, a ratio of 4:1 to 10:1 (average thickness of negative electrode/average thickness of positive electrode) is more preferred.

The separator is based on a polyolefin.

The electrolyte contains potassium hydroxide (KOH) or a mixture of sodium hydroxide (NaOH) and lithium hydroxide (LiOH) or a mixture of KOH, NaOH and LiOH.

The first region and the second region overlap completely.

The first region extends over an area F1 and the second region extends over an area F2, where F1 and F2 have a ratio of 0.8:1 to 1:1.

The negative electrode has a specific capacity K1 of 10 to 100 mAh/g. Within this range, K1 is preferably 20 to 60 mAh/g.

The positive electrode has a specific capacity K2 of 2 to 310 mAh/g. Within this range, K1 is preferably 5 to 240 mAh/g, particularly preferably 10 to 200 mAh/g.

The capacity of the negative electrode Kₙ has a ratio X to the capacity of the positive electrode Kₚ of 1:1 to 2:1. Within this range, a ratio of Kₙ/Kₚ of 1:1 to 1.1:1 is more preferred.

The cell of this example particularly preferably has all of the above features.

Cells according to the two above examples preferably have a capacity of 2 to 10 farad, in particular 3 to 5 farad (in accordance with IEC62391).

Their impedance is preferably 400-500 mOhm at 1 kHz.

In a further particularly preferred example, the cell is a stack cell or a rolled cell. In this example, the cell preferably has at least one of the following features:

The negative electrode is present as thin layer electrode having an average thickness of 0.2 mm to 1.8 mm, in particular 0.2 mm to 1.5 mm.

The negative electrode comprises, as anode storage material, activated carbon and also an additional storage material that can store electric energy by redox reactions, a hydrogen storage alloy or iron or iron oxide powder.

The anode current collector is an electrically conductive foam.

The positive electrode is present as thin layer electrode having an average thickness of 30 μm to 350 μm.

The positive electrode comprises nickel hydroxide and/or nickel oxyhydroxide and/or a derivative of these nickel compounds.

The cathode current collector is an electrically conductive foam.

The average thickness of the negative electrode has a ratio of 0.7:1 to 25:1 to the average thickness of the positive electrode. Within this range, a ratio of 3.0:1 to 15:1 (average thickness of negative electrode/average thickness of positive electrode) is more preferred.

The separator is based on a polyolefin.

The electrolyte contains potassium hydroxide (KOH) or a mixture of sodium hydroxide (NaOH) and lithium hydroxide (LiOH) or a mixture of KOH, NaOH and LiOH.

The first region extends over an area F1 and the second region extends over an area F2, where F1≤F2, with F1 and F2 particularly preferably having a ratio to one another of 1:1 to 1.5:1.

The negative electrode has a specific capacity K1 of 10 to 100 mAh/g. Within this range, K1 is preferably 20 to 60 mAh/g.

The positive electrode has a specific capacity K2 of 2 to 310 mAh/g. Within this range, K2 is preferably 50 to 240 mAh/g, particularly preferably 10 to 200 mAh/g.

The capacity of the negative electrode Kₙ has a ratio X to the capacity of the positive electrode Kₚ of 1:1 to 2:1. Within this range, a ratio of Kₙ/Kₚ of 1:1 to 1.1:1 is more preferred.

The cell according to this example particularly preferably has all of the above features.

In a still further, particularly preferred example, the positive electrode of a cell comprises at least one material from the group consisting of nickel, cobalt, cobalt oxide, cobalt carbonate, cobalt hydroxide, graphite and carbon black as conductivity improver, especially in a proportion of 0.1 to 25% by weight.

The negative electrodes of the cells according to the three examples above particularly preferably contain the additional storage material in a proportion of 0.1 to 8% by weight, particularly preferably 1.0 to 3% by weight, and the carbon-based storage material in a proportion of 10 to 94.9% by weight, particularly preferably 40 to 94.9% by weight (as in all previous examples, the percentages are based on the dry weight of the electrode).

Some of the features mentioned and optionally also further features of the asymmetric cell can be derived from the following description of preferred examples of the cell. In the examples described, many of the above-described features are realized in combination with one another. However, this is not absolutely necessary. It should be emphasized that the optional features described in connection with the examples of the cell presented can also be realized separately from one another. The examples described serve merely for the purposes of explanation and better understanding and are not to be interpreted as constituting any restriction.

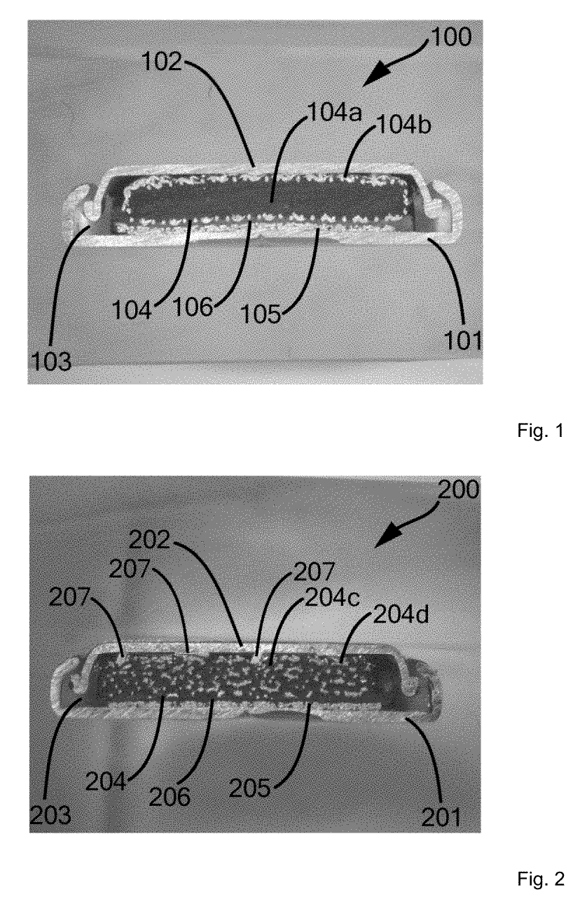

FIG. 1 shows a first example of a cell (photograph of a central section through the cell). To produce the photograph, a cell was produced according to the following method and subsequently parted in the middle.

FIG. 2 shows a second example of a cell (photograph of a central section through the cell). To produce the photograph, a cell was produced according to the following method and subsequently parted in the middle.

### First Example

The cell 100 comprises a liquid-tight and gas-tight housing made up of the housing components 101 and 102. The housing components 101 and 102 are electrically insulated from one another by the seal 103. The electrodes 104 (negative electrode) and 105 (positive electrode) are arranged in the housing. The separator layer 106 is arranged between the two electrodes 104 and 105. The electrodes 104 and 105 and the separator 106 are impregnated with an aqueous alkaline electrolyte.

The housing is a button cell housing. The housing component 101 serves as cell cup, and the housing component 102 serves as cell lid. The seal 103 ensures that no electrolyte can run out from the cell.

The negative electrode 104 comprises a disk-shape tablet 104a having a circular geometry, an average thickness of 1.6 mm and a diameter of 7 mm. The tablet consists essentially of the following components:

70.5% by weight of activated carbon as carbon-based storage material
24% by weight of PTFE as electrode binder
3% by weight of carbon black as additional conductive additive
2.5% by weight of a hydrogen storage alloy as additional storage material which can store electric energy by redox reactions.

To produce such a tablet, a dry mixture of the components indicated was compacted. The percentages indicated are based on the dry weight of the tablet before it was impregnated with an electrolyte.

Apart from the tablet 104a, the negative electrode 104 comprises the mesh 104b composed of nickel with which the tablet is enveloped. This mesh 104b is the anode current collector. Including the anode current collector, the negative electrode weighed 90 mg (dry weight of the electrode).

The positive electrode 105 is likewise configured as a disk-shaped tablet. It likewise has a circular geometry and an average thickness of 0.16 mm and a diameter of 8 mm. The positive electrode 105 consists essentially of the following components:

a foil composed of nickel foam as cathode current collector (60.2% by weight)
nickel hydroxide as cathode storage material (36.2% by weight)
carboxymethyl cellulose as electrode binder (0.4% by weight)
cobalt oxide as conductivity improver (3.2% by weight).

The figures in brackets after the individual components each indicate the proportion by weight of the total weight of the electrode made up of the respective component, with the percentages indicated being based on the dry weight of the electrode (proportion of water <2% by weight) before it was impregnated with an electrolyte.

To produce such a positive electrode, an aqueous, paste-like mixture of the components indicated was worked into the nickel foam foil. Water present was subsequently removed by drying. This was followed by compaction of the resulting composite body, for example, by a calender.

Positive electrodes having the required circular geometry were stamped from the electrode layer obtained in this way. The positive electrode including the cathode current collector weighed 30 mg (dry weight of the electrode).

The separator layer 106 consists of a nonwoven composed of polypropylene. The separator had an average thickness of 250 μm (unpressed) and a diameter of 9 mm.

The aqueous alkaline electrolyte with which the electrodes are impregnated is an aqueous potassium hydroxide solution having a concentration of 6 M potassium hydroxide.

### Second Example

The cell 200 comprises a liquid-tight and gas-tight housing made up of the housing components 201 and 202. The housing components 201 and 202 are electrically insulated from one another by the seal 203. The electrodes 204 (negative electrode) and 205 (positive electrode) are arranged in the housing. The separator layer 206 is arranged between the two electrodes 204 and 205. The electrodes 204 and 205 and the separator 206 are impregnated with an aqueous alkaline electrolyte.

The housing is a button cell housing. The housing component 201 serves as cell cup, and the housing component 202 serves as cell lid. The seal 203 ensures that no electrolyte can run out from the cell.

The electrical contacting of the negative electrode 204 is improved by the expanded metal mesh 207 welded into the cell cup 202.

The negative electrode 204 is configured as a disk-shaped tablet. It has a circular geometry and an average thickness of 1.20 mm and a diameter of 8 mm. The negative electrode 204 consists essentially of the following components:

a foil composed of nickel foam as anode current collector (47.5% by weight)
activated carbon as carbon-based storage material (47.5% by weight)
carboxymethyl cellulose as electrode binder (0.8% by weight)
styrene-butadiene rubber as electrode binder (1.8% by weight)
carbon black SuperC45 as additional conductive additive (1.1% by weight)
a hydrogen storage alloy as additional storage material which can store energy by redox reactions (1.3% by weight).

The figures in brackets after the individual components each indicate the proportion by weight of the total weight of the electrode made up of the respective component, with the percentages indicated being based on the dry weight of the electrode (proportion of water <2% by weight) before it was impregnated with an electrolyte.

The main components of the negative electrode 204, the anode current collector and the anode storage material incorporated therein, are denoted by the reference numerals 204c (anode storage material) and 204d (anode current collector).

The positive electrode 205 is likewise configured as a disk-shaped tablet. It likewise has a circular geometry and an average thickness of 0.13 mm and a diameter of 8 mm. The positive electrode 205 consists essentially of the following components:

a foil composed of nickel foam as cathode current collector (70.0% by weight)
nickel hydroxide as cathode storage material (27.0% by weight)
carboxymethyl cellulose as electrode binder (0.2% by weight)
cobalt oxide as conductivity improver (2.8% by weight).

To produce the positive electrode 205 and the negative electrode 204, an aqueous, paste-like mixture of the components indicated was each worked into the foil composed of nickel foam. Water present was subsequently removed by drying. This was followed by compaction of the resulting composite body, for example, by a calender.

The electrodes 204 and 205 having the required circular geometry were stamped from the electrode layers obtained in this way. The positive electrode weighed 26 mg, the negative electrode weighed 53 mg (dry weight of the electrodes).

The separator layer 106 consists of a nonwoven composed of polypropylene. The separator had an average thickness of 250 μm (unpressed) and a diameter of 9 mm.

The aqueous alkaline electrolyte with which the electrodes are impregnated is an aqueous potassium hydroxide solution having a concentration of 6 M potassium hydroxide. Determination of the electrode capacities of the second example

Determination of the capacity Kₚ of the 30 mg positive electrode was carried out in a button cell test system. The water content of the positive electrode was less than 2% by weight (based on the total weight of the electrode). The electrode was impregnated with a KOH electrolyte (32% by weight of KOH) and connected to an over-dimensioned mischmetal electrode in a size-matched button cell housing.

First, the capacity Kₚ was determined approximately arithmetically or by preliminary tests. In this example, an approximate value of 2.0 mAh was calculated from the known specific capacity of the nickel hydroxide used.

The positive electrode was subsequently activated. For this purpose, the test cell was first charged at a constant current of 0.12 C for 10 hours, then discharged at 0.267 C for 1.5 hours and subsequently charged at 0.1 C for 4 hours. The “C values” describe the respective charging and discharging currents based on the approximately determined capacity. Thus, for example, the current of 0.12 C at a capacity of 2 mAh corresponds to a charging current of 0.24 mA. Charging over 10 hours thus corresponds to 120% of the approximately determined capacity of 2.0 mAh. Discharging over 1.5 hours at 0.267 C analogously corresponds to 40% of the approximately determined capacity of 2.0 mAh.

For the actual measurement, the test cell was charged at 0.2 C at room temperature (23° C.±2° C.) until a final discharge voltage of 1.0 V had been reached, and subsequently charged at 0.1 C for 16 hours. This procedure was repeated twice. The capacity Kₚ of the positive electrode was determined by measuring the discharge current in the third discharge of the test cell by formula (2):

Kₚ=I_{DISCHARGE CURRENT}×t_{DISCHARGE TIME} [mAh] (2).

Determination of the capacity of the negative electrode Kₙ was carried out by a three-electrode measurement in a glass beaker. For this purpose, the negative electrode was stored for a time of 12 hours in a KOH electrolyte (32% by weight of KOH) heated to 80° C. and subsequently connected to an over-dimensioned activated carbon electrode. An Hg/HgO electrode served as reference electrode.

The electrode was charged in the potential range OCV÷−1.0V vs. Hg/HgO at room temperature (23° C.±2° C.) first at a charging current of 1.3 mA (23 mA/g of activated carbon in the electrode), then discharged at a discharge current of 1.3 mA. This procedure was repeated four times. The capacity Kₙ of the negative electrode was determined by measurement of the discharge current in the fifth discharge by formula (3):

Kₙ=I_{DISCHARGE CURRENT}×t_{DISCHARGE TIME} [mAh] (3).

In this way, the capacities Kₚ and Kₙ were determined. Taking into account the weight m of the electrodes examined, the specific capacities (K1 (K1=Kₙ/m_{negative electrode} [mAh/g]) and K2 (K2=Kₚ/m_{positive electrode} [mAh/g])) were calculated.

The capacity Kₙ of the negative electrode was 2.13 mAh. The specific capacity K1 calculated therefrom was 32.9 mAh/g.

The capacity Kₚ of the positive electrode was 1.95 mAh. The specific capacity K2 calculated therefrom was 44.8 mAh/g.

The capacity of the negative electrode Kₙ thus had a ratio X to the capacity of the positive electrode Kₚ of 1.09:1.

1.-6. (canceled)

7. An asymmetric, secondary electrochemical cell comprising:
a negative electrode containing
as anode storage material a carbon-based storage material that allows the storage of electric charge in the electrode by formation of an electric double layer and an additional storage material that can store electric energy by redox reactions, and
an anode current collector;
a positive electrode containing
as cathode storage material nickel hydroxide and/or nickel oxyhydroxide and/or a derivative of these nickel compounds, and
a cathode current collector;
at least one porous separator layer having a first flat side and a second flat side between the negative electrode and the positive electrode;
an aqueous, alkaline electrolyte with which the electrodes and the separator are impregnated;
a housing that encloses the electrodes, the separator and the electrolyte,
wherein
the first flat side comprises a first region which is in areal contact with the anode storage material of the negative electrode and the second flat side comprises a second region which is in areal contact with the cathode storage material of the positive electrode,
the first region and the second region overlap at least partly in an overlap region,
the additional storage material is present in a proportion of 0.1 to 8% by weight in the negative electrode, based on the dry weight thereof, and
the capacity of the negative electrode Kₙ has a ratio X to the capacity of the positive electrode Kₚ of 0.7:1 to 5:1.

8. The cell as claimed in claim 7, wherein the capacity of the negative electrode Kₙ has a ratio X to the capacity of the positive electrode Kₚ of 1:1 to 5:1.

9. The cell as claimed in claim 7, further comprising at least one of:
the carbon-based storage material is at least one material selected from the group consisting of activated carbon (AC), activated carbon fibers (AFC), carbide-derived carbon (CDC), carbon aerogel, graphite (graphene) and carbon nanotubes (CNTs),
the negative electrode contains, as anode storage material, not only the carbon-based storage material, but also an additional storage material that can store electric energy by redox reactions in a proportion of 0.1 to 8% by weight,
the anode storage material is present in a proportion of 40 to 95% by weight in the negative electrode,
the negative electrode contains an electrode binder in a proportion of 0.1 to 30% by weight,
the additional storage material is a hydrogen storage alloy or iron or iron oxide powder or a redox-active compound such as titanium dioxide,
the negative electrode is present as a tape, a thin layer or a tablet,
the anode current collector is a power outlet lead forming a three-dimensional conductive matrix in which the anode storage material, an electrically conductive foam, an electrically conductive nonwoven, an electrically conductive felt or an electrically conductive woven fabric is embedded,
the anode current collector is a mesh or gauze enveloping the negative electrode,
the anode current collector is present in a proportion of 5 to 60% by weight in the negative electrode, and
the negative electrode has a specific capacity K1 of 1 to 150 mAh/g.

10. The cell as claimed in claim 7, further comprising at least one of:
the positive electrode contains not only the cathode storage material, but also at least one conductivity improver selected from the group consisting of nickel, cobalt, cobalt oxide, cobalt carbonate, cobalt hydroxide, graphite and carbon black in a proportion of 0.1 to 25% by weight,
the cathode storage material is present in a proportion by weight of 1 to 95% by weight in the positive electrode,
the positive electrode contains an electrode binder in a proportion of 0.1 to 8% by weight,
the cathode current collector is a power outlet lead forming a three-dimensional conductive matrix in which the cathode storage material, an electrically conductive foam, an electrically conductive nonwoven, an electrically conductive felt or an electrically conductive woven fabric is embedded,
the cathode current collector is an electrically conductive foil, an electrically conductive gauze or an electrically conductive mesh,
the cathode current collector is present in a proportion by weight of 5 to 60% by weight in the positive electrode,
the positive electrode has a specific capacity K2 of 40 to 310 mAh/g.

11. The cell as claimed in claim 7, further comprising at least one of:
the negative electrode has an average thickness D1 of 30 μm to 800 μm,
the positive electrode has an average thickness D2 of 30 μm to 500 μm,
the average thickness of the negative electrode has a ratio of 0.7:1 to 25:1 to the average thickness of the positive electrode,
the first region and the second region completely overlap one another,
the first region extends over an area F1 and the second region extends over an area F2, where F1 and F2 have a ratio to one another of 0.8:1 to 10:1.

12. The cell as claimed in claim 7, further comprising:
the negative electrode is or comprises a tablet having an average thickness of 0.2 mm to 1.8 mm,
the negative electrode comprises activated carbon as anode storage material,
as additional storage material that can store electric energy by redox reactions, the negative electrode comprises a hydrogen storage alloy, a redox-active titanium dioxide compound or iron or iron oxide powder,
the negative electrode contains a PTFE, SBR, PVA, acrylate, PEO and/or CMC binder as an electrode binder,
the anode current collector is an electrically conductive foam,
the positive electrode is present as a tablet having an average thickness of 30 μm to 350 μm,
the positive electrode contains a PTFE, SBR, PVA, acrylate, PEO and/or CMC binder as an electrode binder,
the cathode current collector is an electrically conductive foam,
the average thickness of the negative electrode has a ratio of 2:1 to 20:1 to the average thickness of the positive electrode,
the separator is based on a polyolefin,
the electrolyte contains potassium hydroxide (KOH) or a mixture of sodium hydroxide (NaOH) and lithium hydroxide (LiOH) or a mixture of KOH, NaOH and LiOH,
the negative electrode has a specific capacity K1 of 10 to 100 mAh/g,
the positive electrode has a specific capacity K2 of 2 to 310 mAh/g, and
the capacity of the negative electrode Kₙ has a ratio X to the capacity of the positive electrode Kₚ of 1:1 to 2:1.
